(19) United States
(12) Patent Application Publication
(10) Pub. No.: US 2026/0275550 A1
(43) Pub. Date: Sep. 17, 2026

(54) POROUS CATALYTIC MEMBRANE, MEMBRANE ELECTRODE ASSEMBLY AND WATER ELECTROLYSIS DEVICE

(71) Applicant: The Hong Kong University of Science and Technology (Guangzhou), Guangzhou (CN)

(72) Inventors: Xingwei Chen, Guangzhou (CN); Xingchen Guo, Guangzhou (CN); Xin Ma, Guangzhou (CN); Ping Gao, Guangzhou (CN)

(21) Appl. No.: 19/232,822

(22) Filed: Jun. 9, 2025

(30) Foreign Application Priority Data
Mar. 13, 2025 (CN) 202510299698.X

(51) Int. Cl. C25B 13/02; C25B 1/04; C25B 9/23; C25B 13/08

(52) U.S. Cl. CPC C25B 13/02; C25B 1/04; C25B 9/23; C25B 13/08

(57) ABSTRACT

Provided are a porous catalytic membrane, a membrane electrode assembly and a water electrolysis device. The porous catalytic membrane includes a porous polymer membrane formed by interweaving randomly arranged nanofibers and a catalyst coated on a surface of the nanofibers. The porous polymer membrane has a self-supporting structure and a large specific surface area, providing a large number of loading sites for the catalyst. The catalyst can be directly anchored onto the nanofibers of the porous polymer membrane through a physical or chemical method to achieve uniform dispersion without the need for coating by ionomers, thereby avoiding high costs and performance degradation caused by the adoption of ionomers. The exposure degree of the catalytic active sites is significantly increased, thereby enhancing utilization efficiency of the catalyst and reducing the amount of noble metal catalysts.

### CROSS-REFERENCE TO RELATED APPLICATION

This application claims the benefit of Chinese patent application No. 202510299698.X, titled "POROUS CATALYTIC MEMBRANE, MEMBRANE ELECTRODE ASSEMBLY AND WATER ELECTROLYSIS DEVICE", filed on Mar. 13, 2025, which is incorporated herein by reference in its entirety.

### TECHNICAL FIELD

This disclosure relates to the field of new energy technology, in particular relates to a porous catalytic membrane, a membrane electrode assembly and a water electrolysis device.

### BACKGROUND

With the continuous growth of global demand for clean energy and low-carbon economy, hydrogen energy, as an efficient and pollution-free energy carrier, is receiving increasing attention. Proton exchange membrane (PEM) water electrolysis technology and anion exchange membrane (AEM) water electrolysis technology have become the core paths for large-scale green hydrogen production due to their respective advantages. The PEM water electrolysis technology is renowned for its high current density, rapid dynamic response and compact system design, and the AEM water electrolysis technology has attracted much attention due to its ability to operate under alkaline conditions with non-noble metal catalysts, reduced costs and enhanced system durability. However, in the PEM water electrolysis system and the AEM water electrolysis system, the overall performance and economy largely depend on the design and preparation process of the electrodes.

At present, a noble metal (such as platinum or iridium) is commonly used as a catalyst in the electrode for the PEM water electrolysis, and the noble metal is combined with an ionomer (such as a perfluorosulfonic acid polymer) to be used as a binder and a conductive medium to achieve uniform dispersion of the catalyst, good electronic conductivity and proton transport capacity. Similarly, a transition metal-based catalyst (such as an oxide or a hydroxide of nickel, cobalt, and/or iron) is commonly used in the electrode for the AEM water electrolysis, and an ion-conducting polymer or an alkaline ionomer (such as a quaternized polymer) may be introduced to enhance the conductivity of hydroxyl ion (OH⁻) and the structural stability of the electrode. However, in both PEM and AEM systems, there exist certain common problems and technical bottlenecks due to adoption of ionomers: under the action of ionomers, some catalytic active sites may be shielded or coated, which restricts the effective contact between the catalyst and the reactant (such as a water molecule or a hydroxyl ion), thereby reducing the utilization rate of the catalyst; in addition, a high loading amount of noble metals (such as platinum or iridium in PEM) or specific catalyst materials (such as an optimized transition metal compound in AEM) significantly increase the cost of a water electrolysis device. Although the bonding and ion conduction functions of the ionomer in electrodes are indispensable, there may be microscopic defects at the interfaces between the ionomer and the catalyst, a support or the ion-exchange membrane, which can block local electron conduction or ion transport (a proton or a hydroxyl ion), thereby reducing the reaction kinetic efficiency of the electrode. During long-term operation, the ionomer may undergo structural changes due to chemical degradation (such as the decomposition of a sulfonic acid group in an acidic condition or the degradation of a quaternary ammonium group in an alkaline condition), phase separation, or mechanical stripping, resulting in a decrease in catalytic activity, deterioration of electrode structure, and a significant shortened device lifespan. In the PEM system, the chemical stability of the ionomer is affected by oxidative stress under an acidic condition and a high temperature, while in the AEM system, the alkaline stability of the ionomer is challenged by hydroxyl ion attack and polymer chain breakage. In addition, the component optimization, uniform dispersion and stability control of the ionomer pose high requirements for the precise regulation of process parameters. Regarding both the acidic compatibility of the ionomer in the PEM system and the alkaline resistance and ionic conductivity of the ionomer in the AEM system, the preparation processes of the water electrolysis systems require complex process design and quality control, which not only increases the production difficulty, but also significantly increases the production cost and limits the economic feasibility of them in large-scale applications.

### SUMMARY

This disclosure provides a porous catalytic membrane, a membrane electrode assembly and a water electrolysis device, aiming to provide an ideal platform for the uniform loading of the catalyst and eliminating the reliance of the catalyst on ionomers.

In a first aspect, provided herein is a porous catalytic membrane, comprising:

a porous polymer membrane formed by interweaving randomly arranged nanofibers; and,

a catalyst coated on a surface of the nanofibers.

Optionally, the porous polymer membrane is made of polyolefin.

Optionally, the porous polymer membrane is prepared through a method comprising the following steps:

Step 1: combining a petroleum jelly, a polyolefin and an antioxidant, wherein the petroleum jelly includes petrolatum, white vaseline or a semi-solid mixture of hydrocarbons;

Step 2: stirring the petroleum jelly, the polyolefin and the antioxidant to form a suspension;

Step 3: feeding the suspension into an extruder to produce a gel filament;

Step 4: pressing the gel filament to form a gel film;

Step 5: stretching the gel film to a desired set of dimensions;

Step 6: subjecting the stretched gel film to an annealing temperature; and

Step 7: extracting the petroleum jelly from the stretched gel film.

Optionally, the porous polymer membrane is biaxially oriented, and the nanofibers of the porous polymer membrane comprise a shish-kebab structure.

Optionally, the porous polymer membrane is made of ultra-high-molecular-weight polyethylene (UHMWPE), and a molecular weight of the UHMWPE is 1,000,000-15,000,000 g/mol.

Optionally, a pore size of the porous polymer membrane is 15-500 nm.

Optionally, a porosity of the porous polymer membrane is 15%-90%.

Optionally, a tensile strength of the porous polymer membrane is 100-2,000 MPa.

Optionally, a breaking elongation of the porous polymer membrane is 5%-300%.

Optionally, a diameter of the nanofibers is 1-100nm.

Optionally, a thickness of the porous polymer membrane is 15-500 nm.

Optionally, a catalyst loading is 0.01-0.5 mg/cm².

Optionally, the catalyst is at least one of a transition metal, a transition metal alloy, or a compound formed by a transition metal and an element of Group VA or Group VIA.

Optionally, the catalyst is deposited on the surface of the nanofibers through at least one of the following processes: a physical vapor deposition process, an atomic layer deposition process, an electrochemical deposition process, a solution dip coating process, a spray deposition process, a sol-gel method, and a chemical in-situ growth process.

In a second aspect, provided herein is a membrane electrode assembly, comprising an ion-exchange membrane, and an anode catalyst layer and a cathode catalyst layer respectively bonded to two sides of the ion-exchange membrane, wherein at least one of the anode catalyst layer and the cathode catalyst layer is the porous catalytic membrane as described above.

Optionally, the porous catalytic membrane is bonded to the ion-exchange membrane through a hot-press transfer process.

Optionally, the hot-press transfer process is carried out at a processing temperature of 100 °C. -130 °C., a pressure applied during hot-pressing is 2-5 MPa, and the hot-pressing is carried out for 1-10 minutes.

Optionally, the ion-exchange membrane is prepared through a method comprising the following steps:

applying a solution or a dispersion containing an ion-exchange membrane material to at least one surface of the porous catalytic membrane, and forming the ion-exchange membrane on the porous catalytic membrane after curing.

In a third aspect, provided herein is a water electrolysis device, comprising the porous catalytic membrane as described above or the membrane electrode assembly as described above.

This disclosure has the following beneficial effects:

In this disclosure, a porous polymer membrane formed by interweaving randomly arranged nanofibers is adopted as a support for the catalyst. The porous polymer membrane has a self-supporting structure and a large specific surface area, which provides a large number of loading sites for the catalyst. The catalyst can be directly anchored onto the nanofibers of the porous polymer membrane through a physical or chemical method to achieve uniform dispersion without the need for coating by ionomers, thereby avoiding the high cost and performance degradation caused by the adoption of ionomers. The exposure degree of the catalytic active sites is significantly increased, thereby enhancing the utilization efficiency of the catalyst and reducing the amount of noble metal catalysts. In addition, the porous catalytic membrane with the porous polymer membrane adopted as a substrate and the ion-exchange membrane (usually made of polymer materials) have excellent interfacial contact characteristics, which is conducive to achieving the integrated combination of the two. Therefore, the technical solution of this disclosure eliminates the reliance on ionomers, improves the utilization rate of the catalyst, reduces the manufacturing cost of the membrane electrode, and optimizes the interface characteristics between the catalyst layer and the ion-exchange membrane, which can significantly enhance the mass transfer efficiency, catalytic activity and long-term stability of the electrode for water electrolysis, providing a solid technical support for high-performance, high-reliability and low-cost hydrogen energy production.

### BRIEF DESCRIPTION OF THE DRAWINGS

To more clearly explain the technical solutions in embodiments of this disclosure or the prior art, provided below is a brief introduction to the drawings of the embodiments or the prior art. It is obvious that these drawings described below show some embodiments of this disclosure. Those skilled in the art can obtain other drawings based on these drawings without making creative efforts.

FIG. 1 shows a SEM (scanning electron microscopy) image of surface morphology of the UHMWPE membrane in some embodiments of this disclosure;

FIG. 2 shows SEM images of surface morphology of Pt-PE electrodes with different sputtering thicknesses in some embodiments of this disclosure;

FIG. 3 shows a cross-sectional SEM image of a PEM membrane electrode assembly prepared through a hot-pressing transfer process using a Pt-PE electrode in some embodiments of this disclosure;

FIG. 4 is a structural schematic diagram of a magnetron sputtering device adopted in some embodiments of this disclosure;

FIG. 5 is a structural schematic diagram of a water electrolysis device in some embodiments of this disclosure;

FIG. 6 shows linear sweep voltammetry curves of the electrodes in experimental and control groups in a hydrogen evolution reaction in some embodiments of this disclosure;

FIG. 7 shows a bar graph of overpotential of the electrodes in experimental and control groups in a hydrogen evolution reaction in some embodiments of this disclosure;

FIG. 8 shows linear sweep voltammetry curves of a 40 nm Pt-PE electrode and a commercial Pt/C electrode in their initial states and after 10,000 cyclic voltammetry cycles in some embodiments of this disclosure;

FIG. 9 shows an electrochemical impedance spectrum (EIS) of the electrodes in experimental and control groups in a hydrogen evolution reaction in some embodiments of this disclosure;

FIG. 10 shows a voltage-current density curve of a 45nm Pt-PE electrode in PEM water electrolysis in some embodiments of this disclosure;

FIG. 11 shows voltage-current density curves of the Pt-PE electrodes with different sputtering thicknesses for PEM water electrolysis in some embodiments of this disclosure;

FIG. 12 shows voltage-current density curves of the 45 nm Pt-PE electrode and a commercial Pt/C electrode for PEM water electrolysis in some embodiments of this disclosure;

FIG. 13 shows voltage-current density curves of the 45 nm Pt-PE electrode for PEM water electrolysis at different temperatures in some embodiments of this disclosure;

FIG. 14 shows voltage-current density curves of the 45 nm Pt-PE electrode for PEM water electrolysis in their initial states and after an accelerated aging test involving 40,000 cycles in some embodiments of this disclosure;

FIG. 15 shows long-term stability test data of a 45 nm Pt-PE electrode at different current densities in some embodiments of this disclosure;

FIG. 16 shows a Pt-PE electrode prepared in some embodiments of this disclosure;

FIG. 17 shows a PEM membrane electrode assembly prepared in some embodiments of this disclosure.

### DESCRIPTION OF REFERENCE NUMERALS

1. chamber; 2. target electrode; 3. target material; 4. rotating platform; 5. power supply; 6. Ar ion; 7. Pt atom; 100. anode plate; 101. oxygen outlet; 200. cathode plate; 201. hydrogen outlet; 300. sealing gasket; 400. titanium felt; 500. carbon paper; 600. membrane electrode assembly.

### DETAILED DESCRIPTION

To make the objectives, features and advantages of this disclosure more obvious and understandable, the technical solutions in embodiments of this disclosure will be described clearly and completely below in conjunction with the drawings. Obviously, the embodiments described below are only part of the embodiments of this disclosure, not all of them. Based on the embodiments in this disclosure, all other embodiments obtained by ordinary technicians in the art without making creative efforts shall fall within the protection scope of this disclosure.

In a first aspect, provided herein is a porous catalytic membrane, which is used as a catalyst layer of a membrane electrode assembly, aiming to provide an ideal platform for the uniform loading of the catalyst and eliminating the reliance of the catalyst on ionomers.

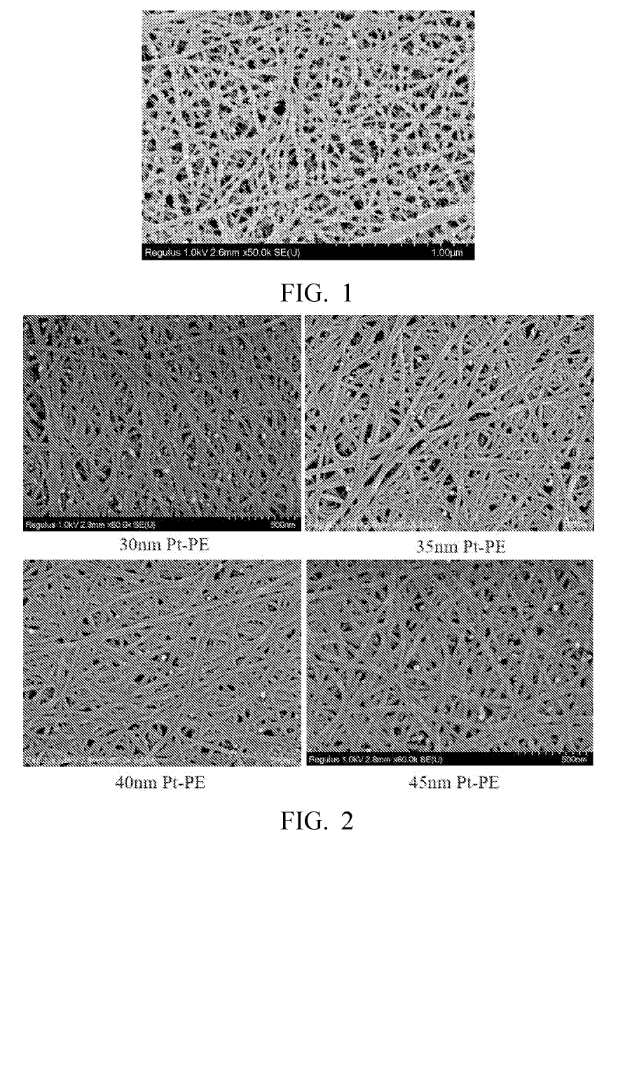

Referring to FIGS. 1 and 2, the porous catalytic membrane provided herein comprises: a porous polymer membrane formed by interweaving randomly arranged nanofibers, and a catalyst coated on a surface of the nanofibers.

In some embodiments of this disclosure, the porous polymer membrane formed by interweaving randomly arranged nanofibers is adopted as a support for the catalyst. The porous polymer membrane has a large specific surface area, which provides a large number of loading sites for the catalyst. The catalyst can be directly anchored onto the nanofibers of the porous polymer membrane through a physical or chemical method to achieve uniform dispersion without the need for coating by ionomers, thereby avoiding the high cost and performance degradation caused by the adoption of ionomers. The exposure degree of the catalytic active sites is significantly increased (in a traditional ink method, the exposure rate of catalytic active sites is approximately 50%, while in some embodiments of this disclosure, the exposure rate of catalytic active sites can exceed 90%), thereby enhancing the utilization efficiency of the catalyst and reducing the amount of noble metal catalysts.

In some embodiments of this disclosure, the porous polymer membrane is made of polyolefin, including but not limited to polyethylene, polypropylene, polybutene, olefin binary copolymers, and olefin polycopolymers.

The research team consisting of the inventors has conducted in-depth studies on the preparation of nano-porous UHMWPE membranes in their previous work. The preparation process of UHMWPE membranes can be referred to processes for preparing membranes from different polyolefin materials.

The porous polymer membrane adoptable to the embodiments of this disclosure can be prepared through a method comprising the following steps:

Step 1: combining a petroleum jelly, a polyolefin and an antioxidant, wherein the petroleum jelly includes petrolatum, white vaseline or a semi-solid mixture of hydrocarbons;

Step 2: stirring the petroleum jelly, the polyolefin and the antioxidant to form a suspension;

Step 3: feeding the suspension into an extruder to produce a gel filament;

Step 4: pressing the gel filament to form a gel film;

Step 5: stretching the gel film to a desired set of dimensions;

Step 6: subjecting the stretched gel film to an annealing temperature; and

Step 7: extracting the petroleum jelly from the stretched gel film.

In some embodiments, the porous polymer membrane is made of UHMWPE, and a molecular weight of the UHMWPE is 1,000,000 -15,000,000 g/mol.

The prepared porous polymer membrane has a nano-porous structure. By controlling the annealing temperature and cooling rate, polymer melts and solutions can undergo flow-induced transitions into shish-kebab self-reinforced composite crystalline structures. The porous UHMWPE membrane with biaxial orientation can be prepared by stretching the gel film by a biaxial stretching equipment or by stretching the gel film in two perpendicular directions in sequence by a uniaxial stretching equipment.

The term “shish-kebab structure” as used herein refers to that in nanofibers, an extended chain is as a core, and many folded chain segments are grown around the extended chain. The crystals of the extended chain are formed by the extension and arrangement of polymer molecular chains along the stress direction, possessing a high orientation degree and regularity. The crystals of the folded chain segments are a thin sheet-like crystal formed by the arrangement and accumulation of molecular chains in a folded manner on the surface of the extended chain crystals. The shish-kebab structure can significantly improve the mechanical properties and thermal stability of the porous polymer membrane.

The term “biaxial orientation” as used herein refers to that in a process of preparing a porous polymer membrane, a tensile force is applied to the gel film in two mutually perpendicular directions (usually transverse and longitudinal directions), which changes the stacking mode of the polymer molecular chains. Such biaxially oriented porous polymer membrane possesses enhanced mechanical strength, indicating that the biaxial orientation improves the tensile strength, tear strength, toughness and other mechanical properties of the polymer.

In some embodiments of this disclosure, a porous polymer membrane with biaxial orientation and shish-kebab nanofibers is preferred. Such porous polymer membrane has a self-supporting structure and can be used as a matrix material for loading the catalyst without additional supports, thereby avoiding the interface contact resistance problem that may be caused by traditional supports such as carbon paper or titanium felt. The prepared porous polymer membrane has high strength and ultra-thinness characteristics, and can be prepared on a large scale, thus having the potential for industrialization.

In the preparation process of the porous polymer membrane, by adjusting the raw material ratio, extrusion and stretching process parameters, annealing temperature and cooling rate, the mechanical strength, pore structure and thickness of the porous polymer membrane can be designed to meet the requirements for porous polymer membranes in the embodiments of this disclosure.

In some embodiments, a pore size of the porous polymer membrane is 15-500 nm. The pore size within this range is crucial for ensuring that the reactant molecules can successfully enter the pore channels and come into contact with the active sites, while also avoiding the problem of limited gas diffusion caused by overly small pore sizes.

In some embodiments, a porosity of the porous polymer membrane is 15%-90%, such that the porous polymer membrane has excellent air permeability.

In some embodiments of this disclosure, the contact area between the catalyst and the porous polymer membrane can be increased by adjusting the pore structure of the porous polymer membrane. The optimization of the pore structure can also effectively improve the conductivity of the membrane electrode and enhance the catalytic reaction rate. Meanwhile, the excellent air permeability of the porous polymer membrane helps to rapidly diffuse the generated gases during the electrolysis process, reducing the mass transfer problems caused by bubble blockage.

In some embodiments, a tensile strength of the porous polymer membrane is 100-2,000 MPa.

In some embodiments, a breaking elongation of the porous polymer membrane is 5-300%.

The porous polymer membrane provided herein has moderate flexibility, which enables the porous polymer membrane to effectively alleviate thermal stress and prevent the cracking of the catalyst layer during the subsequent process of depositing the catalyst and combining with the ion-exchange membrane, and enables the porous catalytic membrane to be bonded to the ion-exchange membrane through a hot-pressing transfer process, ensuring uniform interfacial pressure transfer during the hot-pressing process and achieving tight and integrated combination of the catalyst layer and the ion-exchange membrane.

In some embodiments, a diameter of the nanofibers is 1 nm-100 nm, such that the nanofibers have good mechanical properties, air permeability and moisture permeability, and are also conducive to the attachment of catalysts.

In some embodiments, a thickness of the porous polymer membrane is 15-500 nm. The ultra-thin porous polymer membrane ensures that the porous catalytic membrane has a low charge transport resistance during the electrolysis process, which helps to improve the electrolysis efficiency.

In some embodiments of this disclosure, the catalyst comprises but is not limited to a transition metal, a transition metal alloy, and a compound formed by a transition metal and an element of Group VA or Group VIA. Transition metal elements typically comprise platinum, iridium, ruthenium, iron, nickel, cobalt and the like. The VA group or VIA group elements that can form a compound with the transition metal element usually comprise oxygen, sulfur, nitrogen, phosphorus and the like.

In the application of water electrolysis, the anode undergoes an oxygen evolution reaction, which requires the catalyst to have good catalytic activity, stability and corrosion resistance. In a PEM (Proton Exchange Membrane) system, the most commonly used anode catalyst materials comprise iridium-based materials (such as IrO₂) and ruthenium-based materials (such as RuO₂). In an AEM (anion Exchange membrane) system, nickel-based materials (such as Ni(OH)₂ and derivatives thereof) and cobalt-based materials can be used as an anode catalyst (AEM).

In a water electrolysis process, the cathode undergoes a hydrogen evolution reaction, which requires the catalyst to have a low hydrogen evolution overpotential, high catalytic activity and good stability. Platinum is the most commonly used hydrogen evolution catalyst. In addition, some non-noble metal materials such as molybdenum disulfide, cobalt phosphide, cobalt nitride and derivatives thereof can also be used as a hydrogen evolution catalyst.

In some embodiments, a catalyst loading is 0.01-0.5 mg/cm².

Compared with a method widely adopted in the prior art for preparing the catalyst layer with an ionomer ink, the technical solution of the present disclosure achieves excellent catalytic performance and stability of the catalyst in the embodiments of this disclosure, while the exposure rate of catalytic active sites can be significantly increased by adopting the porous polymer membrane as a support. Therefore, the amount of noble metal catalysts such as iridium, ruthenium, and platinum or specific catalyst materials can be greatly reduced, thereby reducing the cost of hydrogen production.

In some embodiments of this disclosure, the catalyst may be coated on a surface of the nanofibers of the porous polymer membrane by a physical or a chemical method, comprising but not limited to a physical vapor deposition process, an atomic layer deposition process, an electrochemical deposition process, a solution dip coating process, a spray deposition process, a sol-gel method, a chemical in-situ growth process, or any combination of these process methods, to achieve uniform or selective deposition of the catalyst on the porous polymer membrane.

Specifically, the physical vapor deposition process refers to that materials are converted into atomic, molecular or ionic states through physical means in a vacuum environment, and then deposited on a surface of the substrate via vapor phase transport to form a desired thin film layer. For instance, high-purity metals or metal oxides can be uniformly deposited on a surface of nanofibers in the porous polymer membrane through magnetron sputtering and evaporation processes.

The atomic layer deposition process refers to that a deposited film is formed by alternately pulsing gaseous precursors into a reaction chamber and causing chemical adsorption and reaction on a surface of the substrate to be deposited. Usually, only one layer of atoms or molecules is deposited in each cycle. The deposition thickness can be precisely controlled through continuous repetition of the cycle.

The solution dip coating process refers to that the catalyst particles are uniformly dispersed in a mixed solution of a dispersant and a binder to give a mixture, then the porous polymer membrane is immersed in the mixture, and after adsorption, precipitation and drying, the catalyst particles are finally attached to the nanofibers. This process is simple to operate and suitable for temperature-sensitive porous polymer membrane materials. The spray deposition process adopts a solution containing a catalyst, and differs from the solution dip coating process in that the solution containing a catalyst is sprayed on a surface of the porous polymer membrane, such that the catalyst can be attached to the surface of the porous polymer membrane more uniformly. The sol-gel method refers to that a catalyst precursor is uniformly dispersed in a sol system, and during the process of transforming the sol into a gel, the catalyst precursor can maintain a highly dispersed state to generate catalyst particles with a small and uniformly distributed size, then the resulting sol-gel can be uniformly coated on a surface of the porous polymer membrane through spin-coating.

In the electrochemical deposition process, a layer of carbon film or other conductive materials can be pre-prepared on a surface of the porous polymer membrane, and the porous polymer membrane is placed in an electrolytic cell to deposit catalysts based on electrochemical principles. The chemical in-situ growth process refers to that nucleation is promoted through the surface functional groups or pre-coating of the porous polymer membrane, and the catalyst is directly synthesized on the nanofibers of the porous polymer membrane by strictly controlling reaction conditions such as pH and temperatures.

In a second aspect, provided herein is a membrane electrode assembly.

The membrane electrode assembly provided in an embodiment of this disclosure comprises an ion-exchange membrane, and an anode catalyst layer and a cathode catalyst layer respectively bonded on two sides of the ion-exchange membrane; and at least one of the anode catalyst layer and the cathode catalyst layer is the porous catalytic membrane provided by the above embodiments.

The ion-exchange membrane may be a proton exchange membrane, a cation exchange membrane or an anion exchange membrane. For instance, in water electrolysis application, the proton exchange membrane may consist of perfluorosulfonic acid or modified derivatives thereof, which possesses excellent proton conductivity and chemical durability. The proton exchange membrane may also be an anion exchange membrane formed from quaternary ammonium polymers or functionalized variants thereof, which has outstanding hydroxyl ion conductivity and alkaline chemical stability.

In some embodiments, the porous catalytic membrane may be bonded with the ion-exchange membrane through a hot-press transfer process.

Specifically, the porous polymer membrane has excellent interfacial contact characteristics with most ion-exchange membrane materials (usually polymers). An integrated membrane electrode can be prepared by precisely aligning a porous catalytic membrane deposited with a catalyst with an ion-exchange membrane and applying appropriate temperatures and pressures to ensure a tight bond on their surfaces.

In traditional methods of preparing membrane electrodes, ionomers are mixed with the catalyst to give an ink, then the ink is coated on a surface of the ion-exchange membrane or a porous support. These methods have many disadvantages: for example, weak adhesion between the catalyst layer and the substrate results in insufficient interface bonding strength, which may cause interface peeling during operation, thereby weakening the stability of the electrode and shortening its life-span. It is often difficult to precisely control the thickness and uniformity of the catalyst layer during a spraying process or a coating process, which will have an adverse effect on the mass transfer efficiency and charge transfer efficiency of the electrode, thereby causing fluctuations in overall performance. In addition, the technical solutions involving ionomers include complex processes such as multi-step coating, drying and heat treatment, which not only increases the manufacturing cost and prolongs the manufacturing cycle, but also poses challenges in maintaining the repeatability and consistency of process parameters during a large-scale production, thereby restricting its potential for large-scale industrial application.

By adopting a hot-press transfer process, the porous catalytic membrane loaded with the catalyst can be efficiently bonded to the ion-exchange membrane, thus process steps are saved, solvent consumption and exhaust gas emissions are reduced; besides, the bonding of the catalyst and the membrane is more stable, and the peeling problem of the catalyst layer is effectively solved. Meanwhile, during a large-scale production, the porous catalytic membranes can be separately prepared, then through an established hot-press transfer process, the standard "assembly" of the membrane electrode assembly can be achieved with good repeatability and consistency, indicating feasibility of large-scale industrial application.

In some embodiments, in the hot-press transfer process, the processing temperature may be set at 100 °C. -130 °C. to avoid the degradation of the catalyst or the damage to the membrane materials caused by a high temperature, and to prevent the poor bonding problem caused by a low temperature. The pressure applied during hot pressing may be set at 2-5 MPa to ensure that the catalyst layer can be uniformly transferred to the surface of the ion-exchange membrane, while avoiding excessive deformation of the porous catalytic membrane or damage to the catalyst layer. The hot pressing may be carried out for 1 to 10 minutes.

In some other embodiments, the membrane electrode assembly may also be prepared by a method comprising the following steps:

applying a solution or a dispersion containing an ion-exchange membrane material to at least one surface of the porous catalytic membrane through coating, casting or pouring, and forming the ion-exchange membrane on the porous catalytic membrane after curing.

This process can significantly enhance the bonding strength between the porous catalytic membrane and the ion-exchange membrane by directly preparing the ion-exchange membrane on a surface of the porous catalytic membrane.

This disclosure includes, but is not limited to, the following exemplified embodiments.

Embodiment 1. A porous catalytic membrane, comprising:

a porous polymer membrane formed by interweaving randomly arranged nanofibers, and,

a catalyst coated on a surface of the nanofibers.

Embodiment 2. The porous catalytic membrane according to Embodiment 1, wherein ultra-high-molecular-weight polyethylene (UHMWPE) is adopted for preparing the porous polymer membrane, and a molecular weight of the UHMWPE is 1,000,000 -15,000,000 g/mol.

Embodiment 3. The porous catalytic membrane according to Embodiment 2, wherein the UHMWPE membrane is prepared through a method comprising the following steps:

combining a petroleum jelly, an UHMWPE and an antioxidant, wherein the petroleum jelly includes petrolatum, white vaseline or a semi-solid mixture of hydrocarbons;

stirring the petroleum jelly, the UHMWPE and the antioxidant to form a suspension;

feeding the suspension into an extruder to produce a gel filament;

pressing the gel filament to form a gel film;

stretching the gel film to a desired set of dimensions;

subjecting the stretched gel film to an annealing temperature; and

extracting the petroleum jelly from the stretched gel film.

Embodiment 4. The porous catalytic membrane according to Embodiment 3, wherein the porous polymer membrane is prepared by other polyolefins such as polypropylene, polybutene, olefin binary copolymers or olefin polycopolymers.

Embodiment 5. The porous catalytic membrane according to Embodiment 3, wherein during preparing the porous polymer membrane, a tensile force is applied to the polymer material in two mutually perpendicular directions to make the prepared porous polymer membrane biaxially oriented.

Embodiment 6. The porous catalytic membrane according to Embodiment 3, wherein during preparing the porous polymer membrane, an annealing temperature and cooling rate are controlled to form nanofibers with a shish-kebab structure.

Embodiment 7. The porous catalytic membrane according to Embodiment 1, wherein a pore diameter of the porous polymer membrane is 15-500 nm.

Embodiment 8. The porous catalytic membrane according to Embodiment 1, wherein a porosity of the porous polymer membrane is 15% - 90%.

Embodiment 9. The porous catalytic membrane according to Embodiment 1, wherein a tensile strength of the porous polymer membrane is 100- 2000 MPa.

Embodiment 10. The porous catalytic membrane according to Embodiment 1, wherein a breaking elongation of the porous polymer membrane is 5% to 300%.

Embodiment 11. The porous catalytic membrane according to Embodiment 1, wherein a diameter of the nanofibers of the porous polymer membrane is 1-100 nm.

Embodiment 12. The porous catalytic membrane according to Embodiment 1, wherein a thickness of the porous polymer membrane is 15- 500 nm.

Embodiment 13. The porous catalytic membrane according to any of Embodiments 1-12, wherein the catalyst is deposited on a surface of the nanofibers of the porous polymer membrane; and the catalyst is at least one of a transition metal, a transition metal alloy, or a compound formed by a transition metal and an element of Group VA or Group VIA.

Embodiment 14. The porous catalytic membrane according to Embodiment 13, wherein the catalyst is a hydrogen evolution catalyst.

Embodiment 15. The porous catalytic membrane according to Embodiment 13, wherein the catalyst is an oxygen evolution catalyst.

Embodiment 16. The porous catalytic membrane according to Embodiment 13, wherein the catalyst is deposited on the porous polymer membrane by a magnetron sputtering process.

Embodiment 17. The porous catalytic membrane according to Embodiment 13, wherein the catalyst is deposited on the porous polymer membrane by an evaporation process.

Embodiment 18. The porous catalytic membrane according to Embodiment 13, wherein the catalyst is deposited on the porous polymer membrane by an atomic layer deposition process.

Embodiment 19. The porous catalytic membrane according to Embodiment 13, wherein catalyst particles are uniformly dispersed in a mixed solution of a dispersant and a binder, and the catalyst is deposited on the porous polymer membrane by a solution dip coating process.

Embodiment 20. The porous catalytic membrane according to Embodiment 13, wherein catalyst particles are uniformly dispersed in a mixed solution of a dispersant and a binder, and the catalyst is deposited on the porous polymer membrane by a spray deposition process.

Embodiment 21. The porous catalytic membrane according to Embodiment 13, wherein a catalyst precursor is uniformly dispersed in a sol system, and the catalyst is deposited on the porous polymer membrane by a sol-gel spin-coating process.

Embodiment 22. The porous catalytic membrane according to Embodiment 13, wherein a layer of carbon film or other conductive materials is pre-prepared on a surface of the porous polymer membrane, then the porous polymer membrane is placed in an electrolytic cell, and the catalyst is deposited on the porous polymer membrane by an electrochemical deposition process.

Embodiment 23. The porous catalytic membrane according to Embodiment 13, wherein nucleation is promoted by a surface functional group or a pre-coating of the porous polymer membrane, and the catalyst is directly synthesized on the nanofibers of the porous polymer membrane through a chemical in-situ growth process.

Embodiment 24. The porous catalytic membrane according to any of Embodiments 16-23, wherein a catalyst loading is 0.01-0.5 mg/cm².

Embodiment 25. A membrane electrode assembly, comprising an ion-exchange membrane, and an anode catalyst layer and a cathode catalyst layer respectively bonded to two sides of the ion-exchange membrane, and at least one of the anode catalyst layer and the cathode catalyst layer is the porous catalytic membrane according to any of Embodiments 1-24.

Embodiment 26. The membrane electrode assembly according to Embodiment 25, wherein the porous catalytic membrane is bonded to the ion-exchange membrane through a hot-press transfer process.

Embodiment 27. The membrane electrode assembly according to Embodiment 26, wherein the hot-press transfer process is carried out at a processing temperature of 100 °C. -130 °C., a pressure applied during hot-pressing is 2-5 MPa, and the hot-pressing is carried out for 1-10 minutes.

Embodiment 28. The membrane electrode assembly according to Embodiment 25, wherein a solution or a dispersion containing ion-exchange membrane materials is applied to at least one surface of the porous catalytic membrane, and forming the ion-exchange membrane on the porous catalytic membrane after curing.

Embodiment 29. A water electrolysis device, comprising the membrane electrode assembly according to any of Embodiments 25-28, and a gas diffusion layer, a bipolar plate, as well as a sealing part, a gas separation and treatment component if necessary.

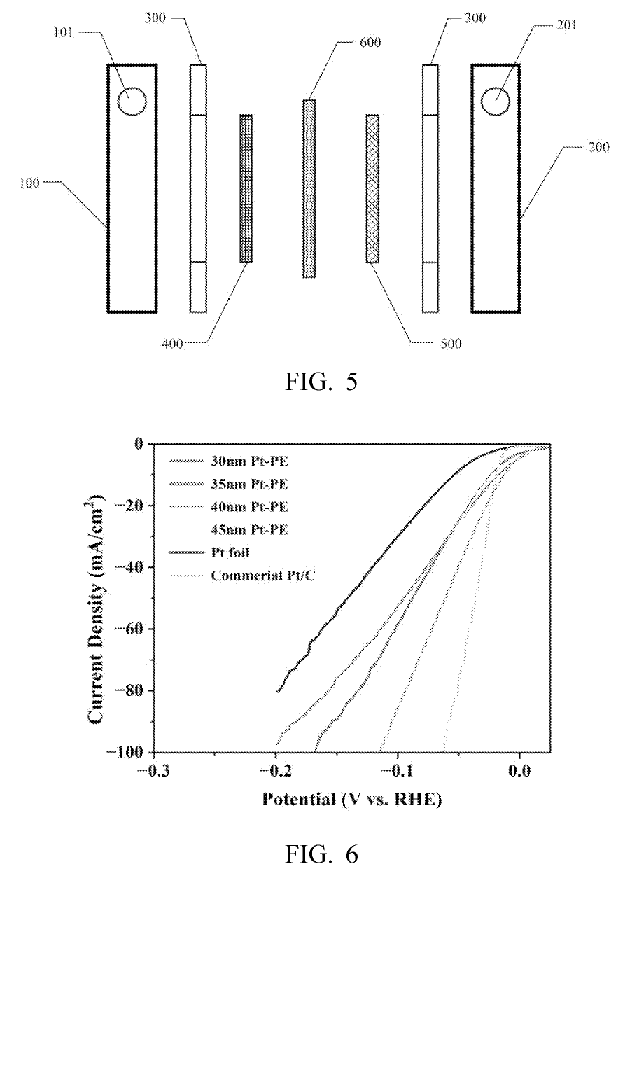

Embodiment 30. A water electrolysis device, referring to FIG. 5, comprising an anode plate 100, a cathode plate 200 and a membrane electrode assembly 600; where the membrane electrode assembly 600 is provided at an anode side with a titanium felt 400 for gas diffusion, and the membrane electrode assembly 600 is provided at a cathode side with carbon paper 500 for gas diffusion; a sealing gasket 300 is provided between the titanium felt 400 and the anode plate, and another sealing gasket 300 is provided between the carbon paper 500 and the cathode plate; the anode plate 100 is provided inside with an oxygen gas processing assembly and an oxygen outlet 101, the cathode plate 200 is provided inside with a hydrogen gas processing assembly and a hydrogen outlet 201 inside; the membrane electrode assembly 600 is the membrane electrode assembly according to any of Embodiments 25-28.

Embodiment 31. A fuel cell, comprising the porous catalytic membrane according to any of Embodiments 1-24 or the membrane electrode assembly according to any of Embodiments 25-28; for example, the porous catalytic membrane may be loaded on an electrode surface of the fuel cell to accelerate an electrochemical reaction on the electrode; and the membrane electrode assembly is suitable for a proton exchange membrane fuel cell or an alkaline anion exchange membrane fuel cell.

Embodiment 32. An ion-exchange membrane electrolysis bath, comprising the porous catalytic membrane according to any of Embodiments 1-24 or the membrane electrode assembly according to any of Embodiments 25-28.

Embodiment 33. A large-scale energy storage device (such as an all-vanadium redox flow battery), comprising the porous catalytic membrane according to any of Embodiments 1-24 or the membrane electrode assembly according to any of Embodiments 25-28.

Embodiment 34. An electrochemical sensor, comprising the porous catalytic membrane according to any of Embodiments 1-24 or the membrane electrode assembly according to any of Embodiments 25-28, for the detection of gases such as carbon dioxide and nitric oxide.

Embodiment 35. A flexible sensor or a flexible energy device, comprising the porous catalytic membrane according to any of Embodiments 1-24 or the membrane electrode assembly according to any of Embodiments 25-28.

Based on the above embodiments, the following examples are also provided herein, for the detailed description of the methods, applications and technical effects of this disclosure. The following examples are not limitations of this disclosure, and those skilled in the art may make adjustments in combination with other examples or embodiments of this disclosure.

### Example

The objective of this example was to prepare a Pt-PE electrode (i.e., an UHMWPE membrane loaded with a Pt catalyst) by using the UHMWPE membrane shown in FIG. 1 as a substrate, and the Pt-PE electrode was used for PEM water electrolysis.

Firstly, a UHMWPE membrane with an appropriate thickness, a pore size and mechanical parameters were adopted. Preferably, a porosity of the UHMWPE membrane was within a range of 50%-70%, and a thickness of the UHMWPE membrane was within a range of 15-500 nm. The porosity range and thickness range were suitable for uniformly depositing the catalyst on the nanofibers from outside to inside of the membrane by magnetron sputtering. The glass transition temperature of the UHMWPE membrane was approximately -120 ℃., and the melting temperature was about 135 ℃., which met the temperature conditions for magnetron sputtering (the required temperature for magnetron sputtering is usually below 100 ℃.). Therefore, during the deposition process, the UHMWPE membrane may maintain dimensional and structural stability, thereby effectively avoiding membrane deformation or abnormal distribution of noble metals caused by thermal effect.

The surfaces of the UHMWPE membrane were modified by methods such as corona treatment or plasma treatment to form polar groups on the surfaces of the membrane, thereby enhancing the adhesion and stability of the catalyst.

Magnetron sputtering of Pt catalyst: the magnetron sputtering device adopted in this example was shown in FIG. 4. The magnetron sputtering device comprised a chamber 1, a target electrode 2, a rotating platform 4, and a power supply 5. Pt was adopted as the target material 3, which was installed on the target electrode 2. The rotating platform 4 was used to carry the UHMWPE membrane on which the catalyst was to be deposited. During magnetron sputtering, the Pt target material was bombarded with Ar ions 6, causing Pt atoms 7 to sputter from the target material and deposit onto the nanofibers of the UHMWPE membrane to form a uniform catalyst layer.

After the sputtering chamber was vacuumized to a set value, in an Ar atmosphere with a flow rate of 30-50 sccm (preferably 30 ssccm), the Ar gas was ionized under a high pressure by applying a pulsed alternating current with a power of 10-150 W (preferably 50W). In a strong electric field, Ar ions moved at a high speed and bombarded the Pt target material to obtain free Pt atoms with a certain initial moving speed. The Pt atoms bombarded the UHMWPE membrane at a high speed and the catalyst layer was formed on the nanofibers. The thickness sputtering rate may be controlled within 12-15 nm/min. In this example, the Pt catalyst was magnetron sputtered on two surfaces of the UHMWPE membrane. Through the magnetron sputtering process, the deposition thickness and uniformity of the catalysts may be precisely controlled. The Pt-PE electrode prepared in this example was shown in FIG. 16.

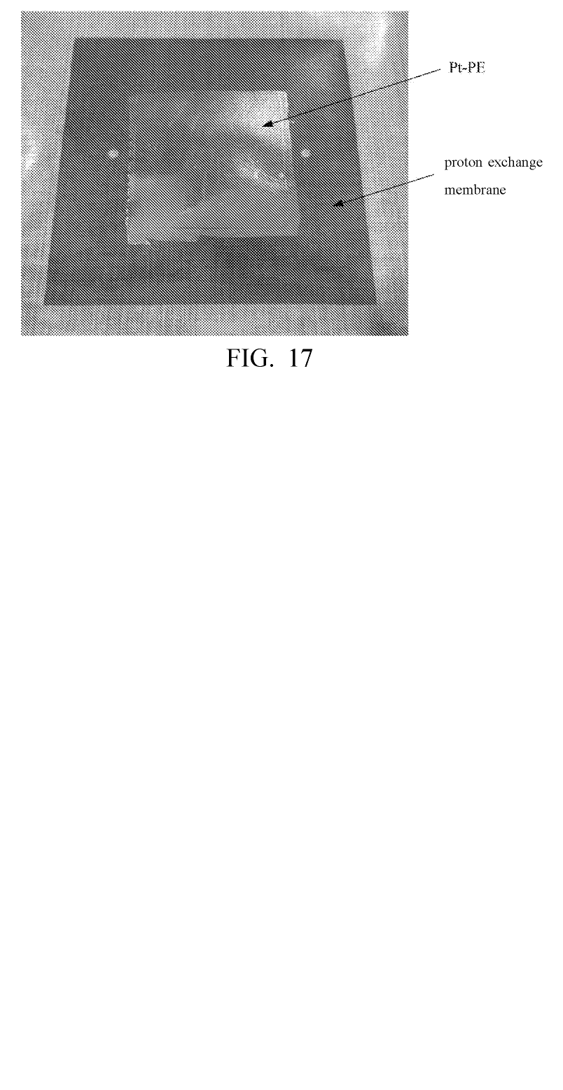

PEM membrane electrode assembly prepared through a hot-press transfer: the UHMWPE membrane deposited with Pt catalyst was aligned with the proton exchange membrane. The catalyst layer was closely bonded to the surface of the proton exchange membrane by applying a certain temperature and pressure, to form an integrated electrode. The temperature of the hot press transfer process was controlled at 100 ℃. to 130 ℃. The pressure applied during hot pressing was controlled at 2-5 MPa, and the hot pressing was carried out for 1-10 minutes. The PEM membrane electrode assembly prepared in this example was shown in FIG. 17.

In this example, a dry process was adopted to prepare the membrane electrode assembly. No solvents or adhesives were used in the hot-press transfer process, which reduces the solvent consumption and exhaust gas emissions, thereby avoiding solvent residues and meeting the requirements of green environmental protection. Besides, the catalyst and the membrane can be efficiently bonded, thereby saving time and avoiding the non-uniformity problem in the coating process. In addition, the bonding between the catalyst and the membrane was more stable, and the peeling problem of the catalyst layer was effectively solved.

Furthermore, the Pt-PE electrodes and the PEM membrane electrode assembly prepared in this example were characterized and tested for their performances.

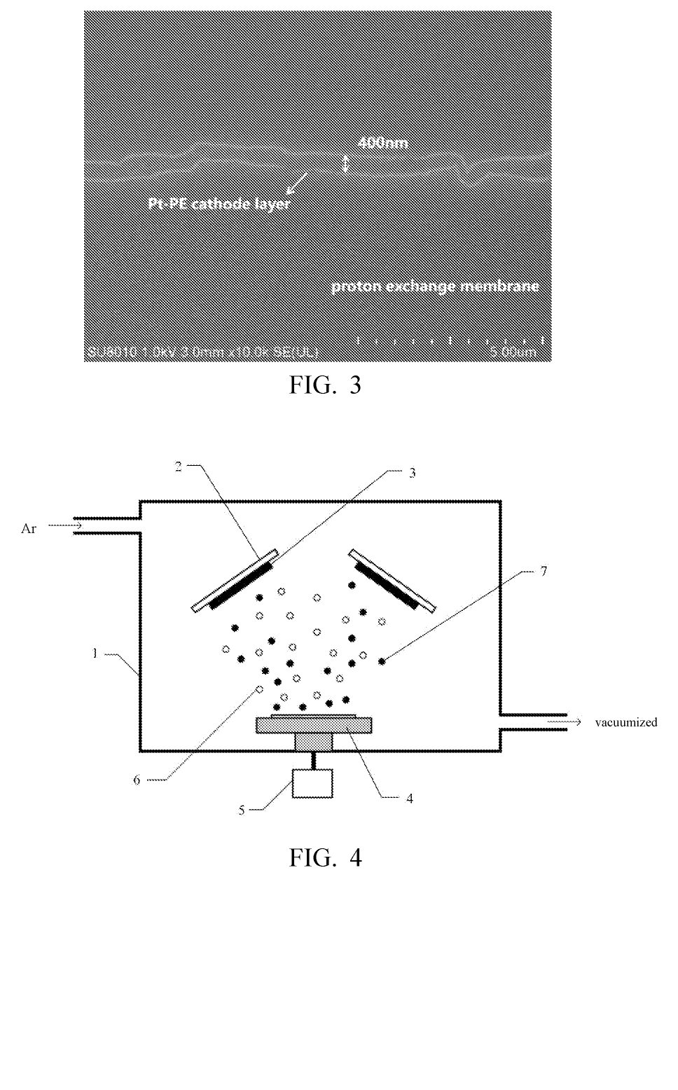

The morphology of the Pt-PE electrodes is shown in FIGS. 2 and 3. FIG. 2 shows SEM images of the surface morphology of the Pt-PE electrodes with different sputtering thicknesses. As can be seen from FIG. 2, the Pt catalysts are uniformly coated on the surfaces of the nanofibers of the UHMWPE membranes. FIG. 3 shows the cross-sectional SEM image of the PEM membrane electrode assembly prepared by a hot-press transfer process using Pt-PE electrode. As shown in FIG. 3, the proton exchange membrane is located below the Pt-PE electrode, and the Pt-PE electrode is closely attached to the proton exchange membrane without any gap therebetween. In this example, an experimental group included four Pt-PE electrodes with sputtering thicknesses of 30 nm, 35 nm, 40 nm and 45 nm, respectively, and a control group included a commercial Pt foil and a commercial Pt/C catalyst.

The electrodes of the experimental group and the control group were subjected to electrochemical tests in a three-electrode system. The test results are shown in FIGS. 6-9.

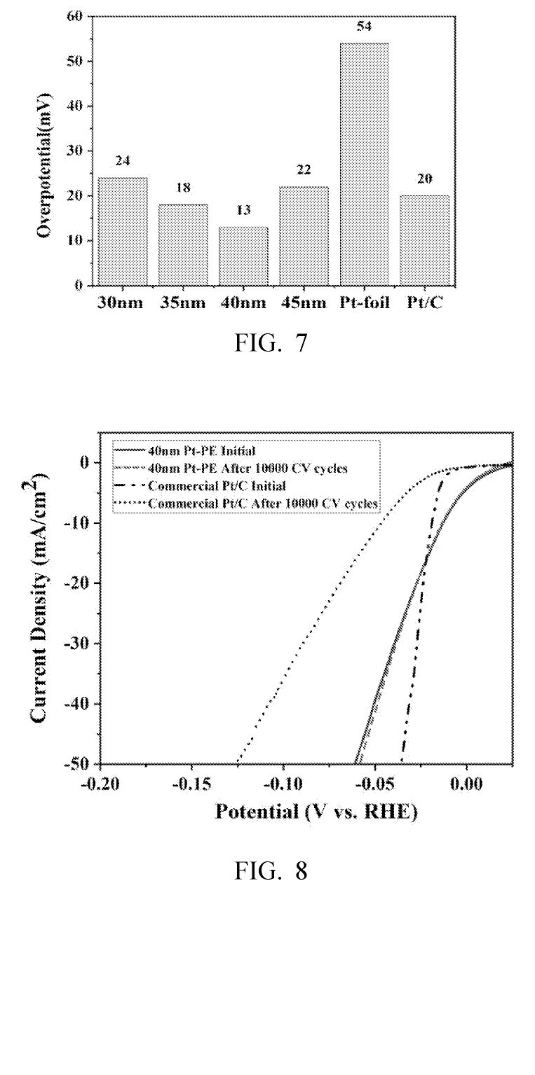

FIG. 6 shows the linear scanning voltammetry (LSV) curves of the electrodes in the experimental group and the control group in the hydrogen evolution reaction (HER), and FIG. 7 shows the bar graph of overpotential of the electrodes in the experimental group and the control group in the HER. As can be seen, all of the Pt-PE electrodes of the experimental group have a relatively low overpotential (close to that of the Pt/C catalyst), indicating that the Pt-PE electrodes of the experimental group meet the catalytic requirements for hydrogen evolution at the cathode in water electrolysis. The Pt-PE electrode with a sputtering thickness of 40 nm has the lowest overpotential (13 mV).

FIG. 8 shows the LSV curves of the 40nm Pt-PE electrode and the commercial Pt/C catalyst in their initial states and after 10,000 cyclic voltammetry cycles. As can be seen, the LSV curve of the 40 nm Pt-PE electrode after 10,000 cyclic voltammetry cycles changes very little compared with the initial LSV, indicating that the 40 nm Pt-PE electrode has more excellent electrochemical stability compared with the commercial Pt/C catalyst.

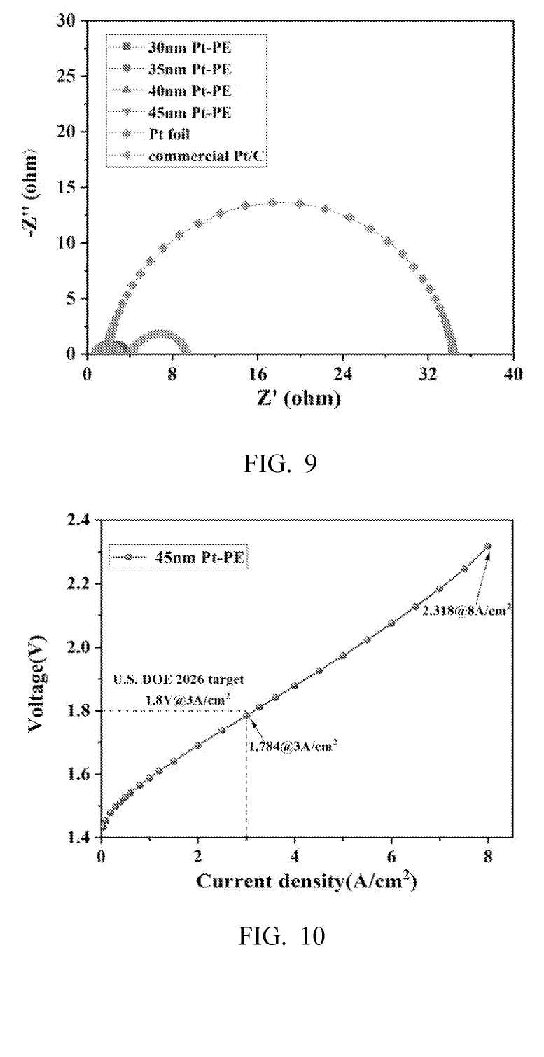

FIG. 9 shows the electrochemical impedance spectrum (EIS) of the electrodes in the experimental group and the control group in the HER. All of the Pt-PE electrodes of the experimental group have a relatively low charge transfer resistance, indicating that the kinetic resistance of the electrode reaction is relatively low.

The electrodes of the experimental and control groups were subjected to electrochemical tests in a PEM water electrolysis device. The test results are shown in FIGS. 10-15.

FIG. 10 shows the voltage-current density curve of the 45 nm Pt-PE electrode in PEM water electrolysis, illustrating the voltage response at different current densities. As can be seen from FIG. 10, the working voltage of the 45nm Pt-PE electrode at a current density of 3 A/cm² is 1.784 V, which is superior to the U.S. DOE 2026 target (according to the target, the working voltage at 3 A/cm² is 1.8 V).

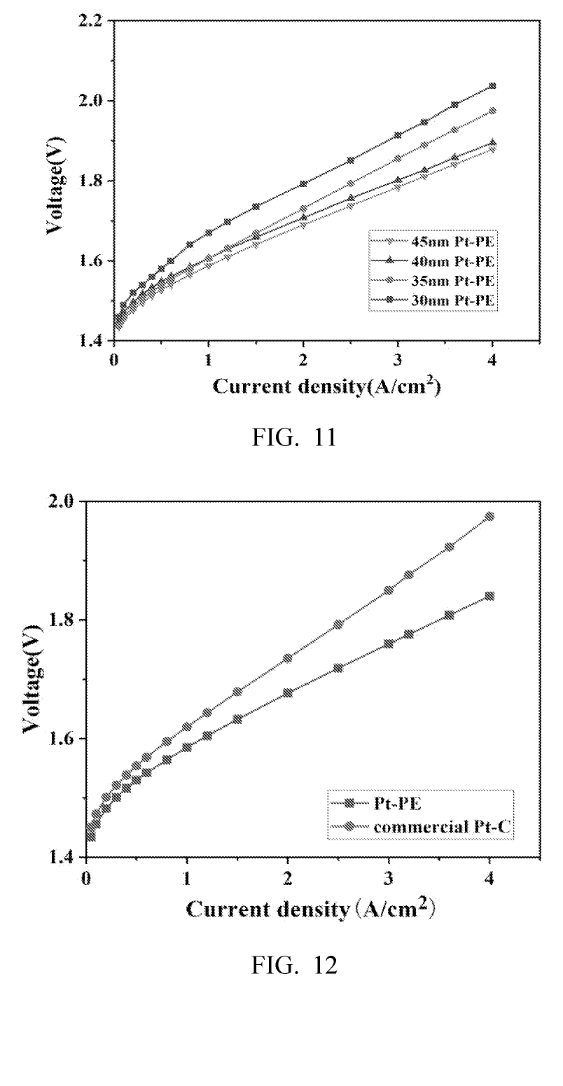

FIG. 11 shows the voltage-current density curves of the electrodes in the experimental group in PEM water electrolysis, illustrating the influence of different sputtering thicknesses of the Pt catalyst on the working voltage for water electrolysis. As can be seen, as the sputtering thickness increases, the lower the working voltage at the same current density, the higher the electrolytic efficiency.

FIG. 12 shows the voltage-current density curves of the 45 nm Pt-PE electrode and the commercial Pt/C electrode in PEM water electrolysis. Under the same current density, the working voltage of the Pt-PE electrode is lower than that of the Pt/C electrode (at a current density of 4 A/m², the working voltage is 160 mV lower). The Pt-PE electrode used in PEM water electrolysis has a higher electrolysis efficiency.

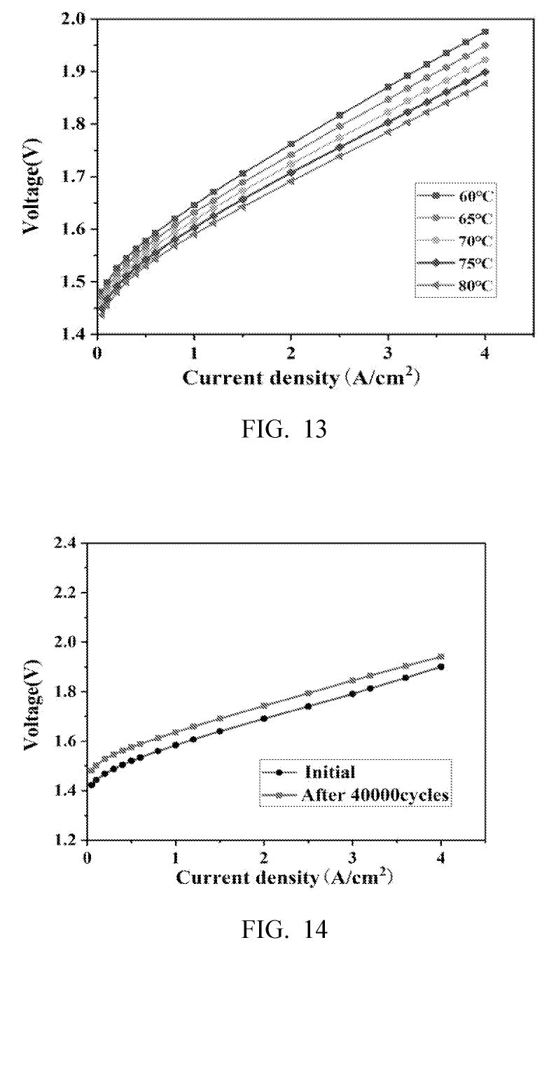

FIG. 13 shows the voltage-current density curves of 45 nm Pt-PE electrode in PEM water electrolysis at different temperatures (60 ℃., 65 ℃., 70 ℃., 75 ℃. and 80 ℃.), illustrating the influence of temperature on the working voltage for water electrolysis. As can be seen, within a range of 60 ℃.-80 ℃., an increase in temperature is beneficial for reducing the working voltage for water electrolysis and improving the electrolysis efficiency.

FIG. 14 shows the voltage-current density curves of the 45 nm Pt-PE electrode in a PEM water electrolysis system, evaluating the durability of the electrode under a high load condition. The operational cyclic stress of the electrode in practical applications can be simulated by conducting accelerated aging test involving 40,000 cycles at a current density of 4 A/cm² (alternating voltage between 1.45 V and 1.9 V, with 30 seconds hold at each voltage). The results show that after accelerated aging test involving 40,000 cycles, the voltage only degrades by approximately 41 mV, indicating that the electrode can still maintain excellent stability and durability under a high load condition, which is of great significance for the practical application of the PEM water electrolysis.

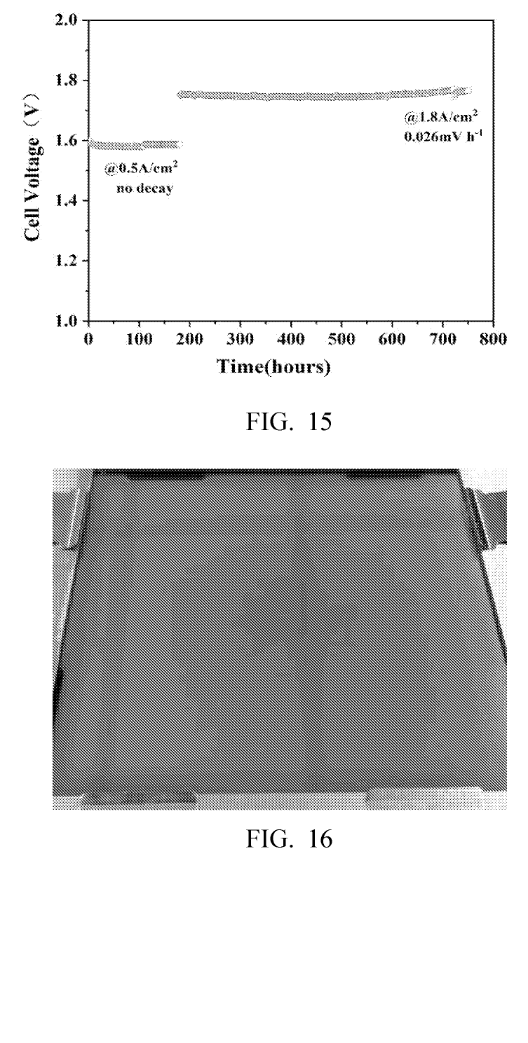

FIG. 15 shows the long-term stability test data of the 45 nm Pt-PE electrode at different current densities, illustrating the long-term stability test results of the electrodes in water electrolysis at different current densities. At a lower current density (0.5 A/cm²), the voltage is approximately 1.6 V and shows almost no degradation during the test lasting for more than a hundred hours. At a higher current density (1.8 A/cm²), the voltage is approximately 1.78 V, and the degradation rate is only 0.026 mV/h, indicating that this system can maintain a very stable voltage even under high loads. In summary, these results indicate that the electrode has excellent durability and stability under different working conditions.

As can be seen from the above characterizations and test results, the Pt-PE electrode prepared in this disclosure has excellent catalytic activity, electrochemical stability and electrolytic efficiency in water electrolysis, and is suitable for the hydrogen energy preparation devices with high-performance, high-reliability and low-cost.

The above embodiments are only provided to illustrate the technical solution of this disclosure but not to limit it. Although this disclosure has been described in detail with reference to the above embodiments, those skilled in the art should understand that they can still modify the technical solutions recorded in the above embodiments or make equivalent replacements for some of the technical features therein. However, these modifications or replacements do not deviate the essence of the technical solutions from the spirit and scope of the technical solutions of this disclosure.

What is claimed is:

1. A porous catalytic membrane, comprising:
a porous polymer membrane formed by interweaving randomly arranged nanofibers, wherein the porous polymer membrane is made of polyolefin; and
a catalyst coated on a surface of the nanofibers.

2. The porous catalytic membrane according to claim 1, wherein the porous polymer membrane is prepared through a method comprising the following steps:
Step 1: combining a petroleum jelly, a polyolefin and an antioxidant, wherein the petroleum jelly includes petrolatum, white vaseline or a semi-solid mixture of hydrocarbons;
Step 2: stirring the petroleum jelly, the polyolefin and the antioxidant to form a suspension;
Step 3: feeding the suspension into an extruder to produce a gel filament;
Step 4: pressing the gel filament to form a gel film;
Step 5: stretching the gel film to a desired set of dimensions;
Step 6: subjecting the stretched gel film to an annealing temperature; and
Step 7: extracting the petroleum jelly from the stretched gel film.

3. The porous catalytic membrane according to claim 2, wherein the porous polymer membrane is biaxially oriented, and the nanofibers of the porous polymer membrane comprise a shish-kebab structure.

4. The porous catalytic membrane according to claim 2, wherein the porous polymer membrane is made of UHMWPE, and a molecular weight of the UHMWPE is 1,000,000-15,000,000 g/mol.

5. The porous catalytic membrane according to claim 1, wherein a pore size of the porous polymer membrane is 15-500 nm.

6. The porous catalytic membrane according to claim 1, wherein a porosity of the porous polymer membrane is 15%-90%.

7. The porous catalytic membrane according to claim 1, wherein a tensile strength of the porous polymer membrane is 100-2,000 MPa.

8. The porous catalytic membrane according to claim 1, wherein a breaking elongation of the porous polymer membrane is 5%-300%.

9. The porous catalytic membrane according to claim 1, wherein a diameter of the nanofibers is 1-100 nm.

10. The porous catalytic membrane according to claim 1, wherein a thickness of the porous polymer membrane is 15-500 nm.

11. The porous catalytic membrane according to claim 1, wherein a catalyst loading is 0.01-0.5 mg/cm².

12. The porous catalytic membrane according to claim 1, wherein the catalyst is at least one of a transition metal, a transition metal alloy, or a compound formed by a transition metal and an element of Group VA or Group VIA.

13. The porous catalytic membrane according to claim 12, wherein the catalyst is deposited on the surface of the nanofibers through at least one of the following processes: a physical vapor deposition process, an atomic layer deposition process, an electrochemical deposition process, a solution dip coating process, a spray deposition process, a sol-gel method, and a chemical in-situ growth process.

14. A membrane electrode assembly, comprising an ion-exchange membrane, and an anode catalyst layer and a cathode catalyst layer respectively bonded to two sides of the ion-exchange membrane, wherein at least one of the anode catalyst layer and the cathode catalyst layer is the porous catalytic membrane according to claim 1.

15. The membrane electrode assembly according to claim 14, wherein the porous catalytic membrane is bonded to the ion-exchange membrane through a hot-press transfer process.

16. The membrane electrode assembly according to claim 15, wherein the hot-press transfer process is carried out at a processing temperature of 100 °C -130 °C, a pressure applied during hot-press is 2-5 MPa, and the hot-pressing is carried out for 1-10 minutes.

17. The membrane electrode assembly according to claim 14, wherein the ion-exchange membrane is prepared through a method comprising the following steps:
applying a solution or a dispersion containing an ion-exchange membrane material to at least one surface of the porous catalytic membrane, and forming the ion-exchange membrane on the porous catalytic membrane after curing.

18. A water electrolysis device, comprising the porous catalytic membrane according to claim 1.

19. A water electrolysis device, comprising the membrane electrode assembly according to claim 14.
